(19) United States
(12) Patent Application Publication
(10) Pub. No.: US 2004/0151394 A1
(43) Pub. Date: Aug. 5, 2004

(54) Symmetrical, highly deterministic, low complexity, temporal transform video codec and vehicle distribution system incorporating same

(76) Inventors: Mikael Soderberg, Pixbo (SE); Caj Zell, Kungsbacka (SE); Subramaniam Sivaramakrishnan, Bangalore (IN); Mark Gill, Newton, MA (US)

Correspondence Address: William R. McClellan, Wolf, Greenfield & Sacks, P.C., 600 Atlantic Avenue, Boston, MA, 02210, US

(21) Appl. No.: 10/356,377

(22) Filed: Jan. 31, 2003

(51) Int. Cl. G06K 9/36

(52) U.S. Cl. 382/250

(57) ABSTRACT

Methods and apparatus for encoding and decoding image data are provided. The method includes selecting a number of sequential image frames in an image frame sequence to achieve a desired encoding performance, such as high quality or low latency, performing a three-dimensional discrete cosine transform on image data in the image frame sequence to provide a three-dimensional matrix of coefficients, and processing the coefficients to provide an encoded bit sequence for transmission. A vehicle distribution system incorporating the encoding and decoding techniques is also provided. The vehicle distribution system includes one or more encoder nodes and one or more decoder nodes coupled to a network for distributing data in a vehicle.

### FIELD OF THE INVENTION

This invention relates to a video compression technology for distributing video over digital, synchronous networks. The technology is particularly useful for distributing video in vehicles, but is not limited to this application. This invention also relates to a vehicle distribution system incorporating the video compression technology.

### BACKGROUND OF THE INVENTION

Today, the major network technologies used for driver information and information systems in vehicles all suffer from bandwidth limitations that make them more or less unsuitable for digital video applications. This results in the car manufacturers and tier-1 suppliers having to design systems that distribute audio, control and some packet-based communication (e.g. TCP/IP or similar) over the digital network and that distribute video in parallel over analog coaxial cables. There would, of course, be a considerable cost reduction of the systems if the video could be distributed over the digital communication bus together with the other media and control data.

Systems based on MPEG and ITU-T standards tend to be unsuitable for several reasons, including algorithm complexity, low predictability and higher cost. In addition, these compression techniques are characterized by relatively long and undeterministic latencies which render them useless for real-time applications.

### SUMMARY OF THE INVENTION

We propose a method of applying a transform to the temporal domain data, thereby creating a highly deterministic, symmetrical video codec of low complexity and low latency. The low complexity of the algorithm results in cheaper porting between different platforms, much lower computing power requirements than competing technology and also in a considerably smaller code footprint than MPEG or ITU-T standard codecs. This makes “end-to-end” software solutions possible, utilizing general-purpose digital signal processors (DSP's), whereas MPEG or ITU-T algorithms typically would require an ASIC or a considerably more powerful programmable device (such as massively parallel long instruction word DSP's). Hence, our solution is cheaper and more flexible than the alternatives.

In one aspect, the invention constitutes a video compression method that utilizes a symmetrical, highly deterministic, low complexity, temporal transform design. This is achieved by performing a high-resolution transform of temporal data previously transformed in the spatial domain. The amount of temporal redundancy that is exploited, is highly configurable and is used to optimally meet requirements from various use cases.

At present, the automotive infotainment systems market is searching for a solution providing low-bandwidth, low latency, high-quality video transmission over a synchronous digital network in vehicles. The solution needs to be of low cost, easily portable to different platforms and highly configurable for different purposes and video sources such as Rear-/Front View Cameras, DVD-video and vehicle navigation information.

The invention provides a solution for a video codec that meets these demands by using a symmetrical, highly deterministic, low complexity, temporal transform video compression technique that is platform independent and is highly configurable to different use cases having different requirement sets.

The specific demands for a Rear-/Front View Camera video transmission on a digital network are: real time, deterministic low latency and low bandwidth.

The invention provides a real time, deterministic low latency video transmission by choosing a suitable configuration of temporal compression. The low bandwidth is achieved by choosing a suitable spatial compression and other compression algorithm parameters dedicated to the specific demands.

The specific demands for a DVD video transmission on a digital network are: high visual quality and low bandwidth.

The invention provides a low bandwidth, high visual quality video transmission by choosing a configuration with a high temporal compression and other algorithm parameters dedicated to the specific demands.

The specific demands for a vehicle navigation information video transmission on a digital network are: real time, deterministic low latency and high visual quality.

The invention provides a real time, deterministic low latency video transmission by choosing a suitable configuration of temporal compression. The low bandwidth is achieved by choosing a suitable spatial compression and other compression algorithm parameters dedicated to the specific demands.

According to an aspect of the invention, a method is provided for encoding image data. The method comprises selecting a number of sequential image frames in an image frame sequence to achieve a desired encoding performance; performing a three-dimensional discrete cosine transform on image data in the image frame sequence to provide a three-dimensional matrix of coefficients; and processing the coefficients to provide an encoded bit sequence.

According to another aspect of the invention, apparatus is provided for encoding image data. The apparatus comprises means for selecting a number of sequential image frames in an image frame sequence to achieve a desired encoding performance; means for performing a three-dimensional discrete cosine transform on image data in the image frame sequence to provide a three-dimensional matrix of coefficients; and means for processing the coefficients to provide an encoded bit sequence.

According to a further aspect of the invention, a method is provided for encoding image data. The method comprises selecting a number of sequential image frames in an image frame sequence to achieve a desired encoding performance; dividing image data representative of the image frame sequence into sub-blocks, wherein each of the sub-blocks has a depth equal to the number of image frames in the image frame sequence; performing a three-dimensional discrete cosine transform on the image data in each of the sub-blocks to provide, for each of the sub-blocks, a three-dimensional matrix of sub-block coefficients; and processing the sub-block coefficients to provide an encoded bit sequence.

According to a further aspect of the invention, a method is provided for transmitting image data from a first location to a second location in a vehicle. The method comprises selecting a number of sequential image frames in an image frame sequence to achieve a desired performance; performing a three-dimensional discrete cosine transform on image data representative of the image frame sequence to provide a three-dimensional matrix of coefficients; processing the coefficients to provide an encoded bit sequence; transmitting the encoded bit sequence from the first location to the second location in the vehicle; and decoding the encoded bit sequence at the second location to provide a transmitted image frame sequence.

According to a further aspect of the invention, a method is provided for processing image data to be transmitted from a first location to a second location in a vehicle. The method comprises performing a three-dimensional discrete cosine transform on image data representative of an image frame sequence to provide a three-dimensional matrix of coefficients; and processing the coefficients to provide an encoded bit sequence for transmission from the first location to the second location in the vehicle.

According to a further aspect of the invention, a method is provided for decoding a bit sequence. The method comprises variable length decoding of an encoded bit sequence representative of image data to provide quantized coefficients; inverse quantization of the quantized coefficients to provide dequantized coefficients; and performing an inverse three-dimensional discrete cosine transform on the dequantized coefficients to provide image data representative of an image frame sequence.

According to a further aspect of the invention, apparatus is provided for distributing a video signal in a vehicle. The apparatus comprises a network for distributing data in the vehicle; an encoder node coupled to the network for receiving a video signal from a video source, for performing a three-dimensional discrete cosine transform on image data derived from the video signal to provide a three-dimensional matrix of coefficients and for processing the coefficients to provide an encoded bit sequence for distribution on the network; and a decoder node coupled to the network for decoding the encoded bit sequence to provide a received video signal.

According to a further aspect of the invention, an encoder node is provided for interfacing a video source to a network. The encoder node comprises a video analog-to-digital converter for converting a video signal to image data; a digital signal processor including means for performing a three-dimensional discrete cosine transform on the image data to provide a three-dimensional matrix of coefficients and means for processing the coefficients to provide an encoded bit sequence; and a network driver device for transmitting the encoded bit sequence on the network.

According to a further aspect of the invention, apparatus is provided for distributing video signals in a vehicle. The apparatus comprises a network for distributing data in the vehicle; a first encoder node coupled to the network for receiving a first video signal from a first video source, for performing a three-dimensional discrete cosine transform on image data derived from the first video signal to provide a three-dimensional matrix of coefficients and for processing the coefficients to provide a first encoded bit sequence, wherein the image data derived from the first video signal comprises a first image frame sequence having a first depth; a first decoder node coupled to the network for decoding the first encoded bit sequence to provide a first received video signal; a second encoder node coupled to the network for receiving a second video signal from a second video source, for performing a three-dimensional discrete cosine transform on image data derived from the second video signal to provide a three-dimensional matrix of coefficients and for processing the coefficients to provide a second encoded bit sequence, wherein the image data derived from the second video signal comprises an image frame sequence having a second depth that is different from the first depth; and a second decoder node coupled to the network for decoding the second encoded bit sequence to provide a second received video signal.

### BRIEF DESCRIPTION OF THE DRAWINGS

For a better understanding of the present invention, reference is made to the accompanying drawings, which are incorporated herein by reference and in which:

FIG. 1 is a block diagram of the coding/decoding process in accordance with an embodiment of the invention;

FIG. 2 is a timing diagram that illustrates the coding/decoding process in accordance with an embodiment of the invention;

FIG. 3 is a flow diagram that illustrates the coding process in accordance with an embodiment of the invention;

FIG. 4 is a block diagram of a vehicle distribution system utilizing the coding/decoding process in accordance with an embodiment of the invention;

FIG. 5 is a block diagram of an embodiment of an encoder node shown in FIG. 4; and

FIG. 6 is a block diagram of an embodiment of a decoder node shown in FIG. 4.

### DETAILED DESCRIPTION

The video compression method performs a discrete cosine transform of the coefficients received from previously transformed spatial data. The amount of temporal redundancy that is exploited is controlled by the number of frames transformed. This is a key design parameter which is used to adjust the system to various requirements, such as “latency over bit rate”, “bit rate over latency”, etc.

The output from the temporal transform is quantized with a quantization matrix obtained using a mathematical expression. The amount of quantization, and consequently the compression ratio, can be controlled at run-time with a reconfigurable scaling factor.

The quantized output is scanned in three dimensions, using a scan table selected from empirical data and fed into a (zero) run-length encoding (RLE) algorithm.

The output from the RLE is variable length encoded using a variable length coding (VLC) table and is copied symbol-wise to an output buffer which is transmitted when full (or last frame encoded in order to avoid latency problems).

The decoder performs the inverse of the above described operations, hence the near-optimal symmetrical nature of the codec.

The encoding and decoding algorithms are designed to work concurrently with the decoder processing the buffer previously produced by the encoder.

A scalable dedicated suite of post-processing algorithms, where emphasis is put on maintaining synchronicity and minimizing latency, is available and can be controlled by the encoder. The basic algorithms are deblocking, averaging and median filters with different windows and decision criteria. These post-processing algorithms are applicable to this solution due to the lack of motion estimation and motion compensation algorithms, typically used in MPEG and ITU-T video compression standards.

The error resiliency is achieved by a design that is derived with the performance of a low bit error rate network and thereby minimizing overhead.

Examples of applications where this invention can be used are:

Rear-/Front View Cameras in vehicles using a digital, synchronous data bus for multimedia communications (including cars, trains and airplanes)

DVD and Video applications in vehicles using a digital, synchronous data bus for multimedia communications (including cars, trains and airplanes)

TV-tuner applications in vehicles using a digital, synchronous data bus for multimedia communications (including cars, trains and airplanes)

Applications where distribution of graphics data over a synchronous, digital network needs to take place (for example navigation computer, video games console output or driver information display (radar, infrared) in vehicle)

Video Conferencing in vehicles using a digital, synchronous data bus for multimedia communications (including cars, trains and airplanes)

The system is described in a sequential manner, following the flow of data.

Forward 3DDCT (three-dimensional discrete cosine transform):

The preparatory step in the compression scheme is to use an orthogonal transform to extract frequency information from the spatial/time-domain data. A sequence, 1, 2, 4 or 8 for example, of captured picture frames represent a 3-dimensional block which is divided into sub-blocks with the sides 8×8 and the depth given by the number of frames collected. The orthogonal transform that is used is the discrete cosine transform (DCT). In order to exploit the temporal redundancy present in natural video content, a DCT is performed in the temporal domain in addition to the well-known 2DDCT of the information in the spatial domain.

F(u,v,w)=α(u)α(v)α(w)ΣiΣjΣk f(x,y,z)* cos((x+½)uπ/8)cos((y+½)vπ/8)cos((z+½)wπ/8) (1)

where

Σi is a summation over index i: x=0 . . . 7

Σj is a summation over index j: y=0 . . . 7

Σk is a summation over index k: z=0, 0 . . . 1, 0 . . . 3 or 0 . . . 7

α(q): 1/√2 for q=0

α(q): 1 otherwise

x,y,z are indices in 3-dimensional space and f(x,y,z) is the pixel value in the corresponding position.

The level of utilization of temporal redundancy is configured by the number of frames collected before encoding (1, 2, 4 or 8 in this example) and this is used to adapt the system to the desired bandwidth vs. latency requirements. It will be understood that a depth of one image frame reduces to the special case of a two-dimensional discrete cosine transform.

The transform of equation (1) yields a three-dimensional matrix of coefficients. For 8×8 (in the spatial dimensions) image sub-blocks, the transform yields a coefficient matrix having sides of 8×8 and a depth equal to the selected depth of the image frame sequence, i.e., a matrix with dimensions 8×8×depth. The 8×8×depth sub-blocks are used to limit computation complexity. However, the invention is not limited in this respect and may utilize larger or smaller sub-blocks, or in principle may process a complete image without dividing the image sequence into sub-blocks.

An example for the case with a temporal depth of 2, taken from actual video data, is followed through the signal chain:

Original: Frame 0:

$$\begin{matrix}117 & 119 & 111 & 97 & 59 & 82 & 103 & 97 \\ 114 & 125 & 127 & 129 & 114 & 121 & 126 & 122 \\ 137 & 141 & 133 & 133 & 126 & 138 & 139 & 119 \\ 166 & 163 & 155 & 159 & 153 & 166 & 158 & 140 \\ 130 & 139 & 152 & 156 & 155 & 167 & 167 & 174 \\ 113 & 119 & 126 & 132 & 146 & 155 & 160 & 165 \\ 112 & 113 & 116 & 124 & 129 & 136 & 142 & 138 \\ 113 & 105 & 117 & 113 & 110 & 110 & 116 & 117\end{matrix}$$

Frame 1:

$$\begin{matrix}119 & 122 & 118 & 113 & 88 & 100 & 113 & 104 \\ 120 & 122 & 119 & 119 & 104 & 118 & 126 & 122 \\ 143 & 143 & 134 & 142 & 140 & 151 & 151 & 134 \\ 160 & 161 & 162 & 168 & 163 & 177 & 174 & 159 \\ 124 & 133 & 145 & 149 & 144 & 159 & 160 & 173 \\ 106 & 106 & 109 & 126 & 134 & 150 & 145 & 158 \\ 113 & 112 & 118 & 123 & 120 & 116 & 109 & 128 \\ 97 & 100 & 109 & 109 & 95 & 86 & 85 & 89\end{matrix}$$

Evaluating equation (1) with this input and the set k (representing depth) equal to [0,1] yields a three-dimensional matrix of coefficients:

After DCT:

$$\begin{matrix}6 & - 14 & 2 & - 3 & - 5 & 6 & 0 & - 6 \\ 2 & 17 & 8 & 0 & - 8 & 5 & - 3 & - 4 \\ - 76 & 18 & 6 & - 8 & 1 & 3 & - 1 & 1 \\ - 6 & - 16 & 6 & - 5 & 1 & - 2 & 1 & - 1 \\ 4 & 12 & 2 & - 5 & - 2 & 3 & 1 & - 1 \\ 7 & 9 & 2 & 5 & - 1 & 1 & - 1 & - 1 \\ - 9 & - 1 & 2 & 3 & - 1 & 0 & - 1 & 1 \\ - 4 & 0 & 1 & - 3 & - 1 & - 1 & 0 & 0\end{matrix}$$

$$\begin{matrix}4 & 0 & 2 & 1 & - 3 & 2 & 0 & 2 \\ - 16 & 7 & 0 & - 4 & 0 & - 1 & 1 & - 2 \\ 4 & - 6 & 4 & 0 & - 1 & 1 & 1 & - 1 \\ 2 & 0 & 0 & - 1 & - 1 & 0 & - 1 & 1 \\ - 2 & 2 & 4 & 1 & 2 & 1 & 1 & - 1 \\ - 9 & 1 & 4 & 1 & - 1 & 1 & - 1 & - 1 \\ - 3 & 3 & 2 & - 3 & - 1 & 0 & 1 & 1 \\ - 2 & - 2 & 1 & 1 & - 1 & 1 & 0 & 0\end{matrix}$$

Quantization:

The transformed coefficients are thereafter passed to the quantization step where individual coefficients are divided by a quantization factor obtained from a quantization matrix. Along with this matrix, a quantization factor is used to control the quantization during run-time for e.g. bit-rate control, i.e.

Q(u,v,w)=nint(F(u,v,w)/(k*q(u,v,w))) (2)

for all

u in [0,7]

v in [0,7]

w in [0,0], [0,1], [0,3] or [0,7]

and where “nint” is the nearest integer and k is the quantization factor, in this case equal to ‘1’. The quantization matrix q(u,v,w) is a three-dimensional matrix. For 8×8×depth image sub-blocks, the quantization matrix has sides of 8×8 and a depth equal to the selected depth of the image frame sequence.

Continuing with the previous example, the quantization matrix q(u,v,w) is

$$\begin{matrix}1 , & 17 , & 31 , & 45 , & 56 , & 38 , & 42 , & 46 , \\ 17 , & 45 , & 38 , & 46 , & 53 , & 59 , & 63 , & 67 , \\ 31 , & 38 , & 50 , & 59 , & 65 , & 70 , & 74 , & 76 , \\ 45 , & 46 , & 59 , & 67 , & 73 , & 76 , & 79 , & 81 , \\ 56 , & 53 , & 65 , & 73 , & 77 , & 80 , & 81 , & 82 , \\ 38 , & 59 , & 70 , & 76 , & 80 , & 82 , & 83 , & 83 , \\ 42 , & 63 , & 74 , & 79 , & 81 , & 83 , & 83 , & 84 , \\ 46 , & 67 , & 76 , & 81 , & 82 , & 83 , & 84 , & 84 ,\end{matrix}$$

$$\begin{matrix}17 , & 45 , & 38 , & 46 , & 53 , & 59 , & 63 , & 67 , \\ 45 , & 46 , & 59 , & 67 , & 73 , & 76 , & 79 , & 81 , \\ 38 , & 59 , & 70 , & 76 , & 80 , & 82 , & 83 , & 83 , \\ 46 , & 67 , & 76 , & 81 , & 82 , & 83 , & 84 , & 84 , \\ 53 , & 73 , & 80 , & 82 , & 83 , & 84 , & 84 , & 84 , \\ 59 , & 76 , & 82 , & 83 , & 84 , & 84 , & 84 , & 84 , \\ 63 , & 79 , & 83 , & 84 , & 84 , & 84 , & 84 , & 84 , \\ 67 , & 81 , & 83 , & 84 , & 84 , & 84 , & 84 , & 84.\end{matrix}$$

The quantization step yields a three-dimensional matrix of quantized coefficients. For 8×8×depth image sub-blocks, the matrix of quantized coefficients has sides of 8×8 and a depth equal to the selected depth of the image frame sequence.

After quantization:

$$\begin{matrix}6 & - 1 & 0 & 0 & 0 & 0 & 0 & 0 \\ 0 & 0 & 0 & 0 & 0 & 0 & 0 & 0 \\ - 2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}$$

$$\begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}$$

Variable Length Encoding:

The output from the quantization step typically contains a large number of zeroes. In order to make the ensuing variable-length encoding perform effectively, these coefficients are rearranged according to a carefully designed scan table.

Following the example with the scan table:

0, 8, 1, 16, 2, 9, 24, 64, 3, 17, 32, 10, 4, 25, 18, 11, 5, 40, 12, 19, 26, 65, 72, 6, 33, 20, 13, 27, 48, 21, 14, 7, 66, 34, 28, 80, 41, 73, 22, 29, 35, 15, 56, 36, 67, 70, 42, 88, 69, 74, 30, 23, 49, 37, 78, 81, 68, 75, 77, 96, 43, 71, 89, 84, 86, 83, 92, 76, 44, 45, 46, 47, 50, 51, 52, 53, 54, 55, 57, 79, 58, 59, 82, 60, 61, 85, 63, 87, 62, 31, 90, 91, 38, 93, 94, 95, 39, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127

where the coefficients represent the order in which the above quantized coefficients should be collected. The numbers in the scan table are used to index the values in the matrix of quantized coefficients in plain reading order, i.e. top-bottom and left-to-right. Thus, the numbers 0-63 index the values in the first 8×8 matrix, and the numbers 64-127 index the values in the second 8×8 matrix. So, for instance, with this scan order, the fifth element collected is the third in reading order. This produces the sequence:

$$\begin{matrix}6 , 0 , - 1 , - 2 , 0 , 0 , 0 , 0 , 0 , 0 , 0 , 0 , 0 , 0 , 0 , 0 , 0 , 0 , 0 , 0 , 0 , 0 , 0 , 0 , 0 , \\ 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 \\ 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , \\ 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , \\ 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 , 0 ,\end{matrix}$$

Continuing with the example, the current bitstream is produced according to the following variable length codewords.

The DC-component is encoded with a fixed number of bits, in this example 12, except when DC-prediction is used. This is a scheme that utilizes the inherent redundancy in the encoded DC-coefficients. During DC-prediction, only the difference of the DC-component from the previous depth's sub-block in the same position as the current is sent and is encoded with the same code tables as the AC-components. Note: Since the DC-component is never quantized, no information loss is introduced as a result of this. The DC-component is here ‘6’, which is encoded as “000000001100,” which is the absolute value of the DC-component left shifted one bit to make room for the sign bit, which in this case is ‘0’ since the encoded number was positive. The next number, a ‘0’, is noted but no encoding takes place and instead the algorithm looks for the next value, which in this case is ‘−1’. Now, the variable length encoder has a run-size pair [1,1] representing [“number of consecutive zeroes”, “absolute value of ensuing non-zero number”] which has an entry in the variable length codetable, specifically “1100” and encoding takes place. Since the original number was ‘−1’, the sign bit is added to the rightmost bit making the sequence “1101”. For completion, the remaining bit generation is described in less detail.

The ‘−2’, with no preceding zeroes, results in an encoding of the following run-size pair: [0,2]. After sign encoding, this coefficient value is encoded as “10011”.

The ensuing 124 zeroes are not encoded at all. Instead a symbol named END_OF BLOCK (“010011”) is added to the bitstream and the decoder correctly decides that only zeroes remained in this sequence.

The bit sequence that is added from this sub-block is therefore “000000001100110110011010011” resulting in a compression factor of 128×8/26=39.4.

To cope with unusual situations, e.g. a large number of consecutive zeroes followed by a comparably large element, the code-tables are accompanied with an escape-coding mechanism that assures that all possible run-size pairs can be uniquely encoded.

The statistical properties of the input to the variable length encoding procedure are different from those of traditional video compression methods based on motion-estimation/motion-compensation. For instance very long run-lengths of zeroes are possible. The variable length encoding tables are therefore equipped with a designated multi-level escape-coding mechanism to further increase compression in addition to the variable length coding tables which are derived using empirical data from a large number of natural video sequences.

The escape-coding is divided into the following cases:

A run of zeroes exceeding an overall max limit and the ensuing elements absolute value=1.

A run of zeroes equal to zero and an element exceeding an overall max limit.

A run of zeroes less than 8 and an element less than 128.

An escape-code for the remaining cases.

The bit stream output from the variable length encoder is packetized into buffers of fixed size for transport over a network. The buffer size is configurable and can be designed to meet recommendations from the network transport protocol.

When the decoder receives the bitstream, parsing of the unique symbols occurs. With the current example, it first examines the first twelve bits (assuming no DC-prediction is utilized) and decides that a ‘6’ has been transmitted as the DC-component. The decoder then parses the ensuing bitstream and upon encountering ‘1101’ decides this is the smallest unique ensuing sequence and therefore decodes it as “one ‘0’ followed by an element of magnitude ‘1’”. Since the last bit was a ‘1’, the element is decided to have been of negative sign, resulting in a decoded sequence of 0,−1 and we now have the element sequence 6, 0, −1. Following the same method, the bits “10011” are decoded as “zero ‘0’ followed by an element of magnitude ‘2’” and compensated for sign with the last bit as ‘−2’. Then the next unique sequence of bits in the bitstream is “010011” which is decoded as END_OF_BLOCK or, more verbally, “nothing but zeroes in the remainder of this sub-block” causing the decoder to add 124 (128−4 symbols already decoded) zeroes to the sequence.

The decoder is essentially performing the inverse of the above described activities from inverse scan and forward.

The inverse quantization equation is given by:

F(u,v,w)=nint(Q(u,v,w)*k*q(u,v,w)) (3)

for all

u in [0,7]

v in [0,7]

w in [0,0], [0,1], [0,3] or [0,7]

where Q(u,v,w) are the elements of the sub-block obtained after inverse scanning the decoded bitstream. The inverse 3D-IDCT is given by the equation:

f(x,y,z)=ΣiΣjΣk α(u)α(v)α(w)F(u,v,w)* cos((x+½)uπ/8)cos((y+π½)vπ/8)cos((z+½)wπ/8) (4)

where

Σ i is a summation over index i: u 0 . . . 7

Σ j is a summation over index i: v=0 . . . 7

Σ k is a summation over index k: w=0, 0 . . . 1, 0 . . . 3 or 0 . . . 7

α(q): 1/√2 for q=0

α(q): 1 otherwise.

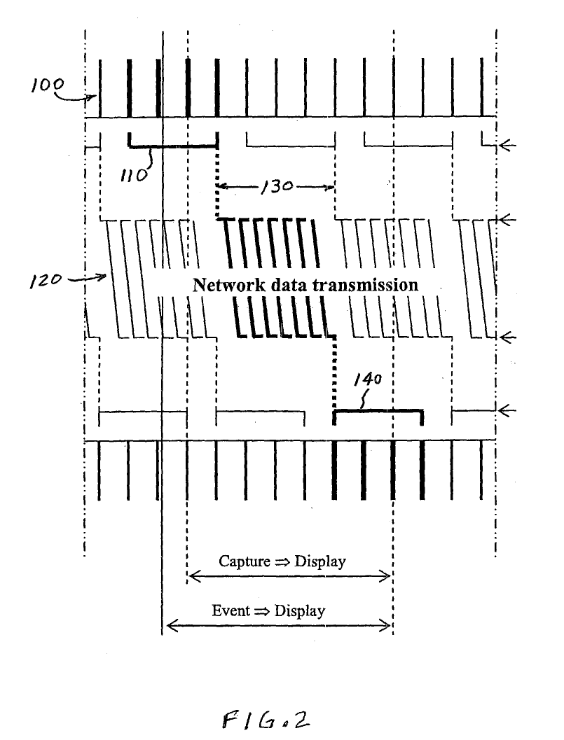

The decoder complexity is slightly less than the encoder due to the creation of the bitstream being more demanding than parsing and decoding the same, but the two algorithms can with good accuracy be considered equally computationally demanding. This makes the concurrent execution of the encoder and decoder possible by allowing the decoder to process a received buffer in parallel with the encoder creating a new. This sequence of events is portrayed in FIG. 2. The only exception to this scheme is that the encoder always sends the transmission buffer when it is finished processing a whole temporal depth, regardless of how filled the buffer is. This is to reduce the increased latency that would otherwise be the result.

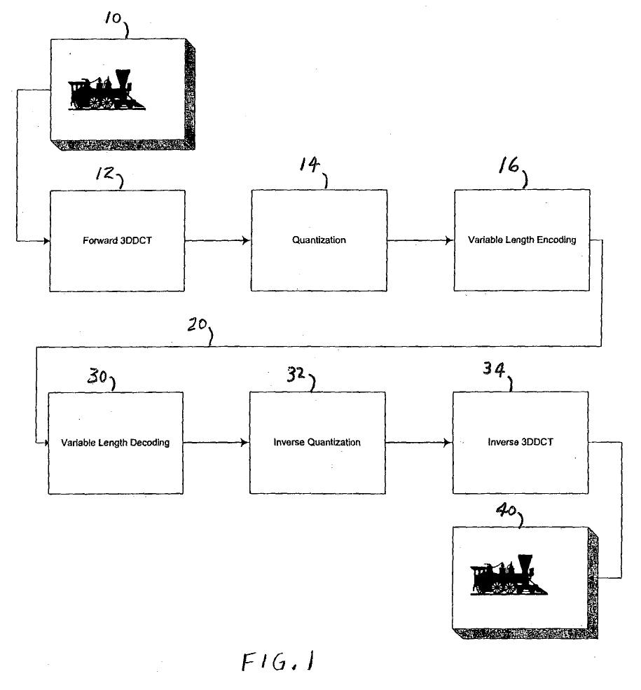

A simplified flow diagram of the encoding/decoding process in accordance with an embodiment of the invention is shown in FIG. 1. An image frame sequence 10, including a selected number of image frames, is acquired. As discussed above, the number of image frames in the image frame sequence, also known as the depth of the image frame sequence, is selected to provide a desired performance. The image frame sequence is encoded by performing a forward three-dimensional discrete cosine transform 12, quantization 14 and variable length encoding 16. The result of the encoding process is an encoded bit sequence that represents the image frame sequence 10. The encoded bit sequence is transmitted on a network 20 or other transmission channel. The received bit sequence is decoded by variable length decoding 30, inverse quantization 32 and performing an inverse three-dimensional discrete cosine transform 34 to generate a received image sequence 40. The quality of the received image frame sequence and the latency (delay) in producing the received image frame sequence are functions of the selected depth of the image frame sequence.

A timing diagram that illustrates network data transmission of encoded information in accordance with an embodiment of the invention is shown in FIG. 2. A waveform 100 represents the timing of a series of image frames generated by a camera, DVD player or other video source. As described above, encoding in accordance with the invention involves processing an image frame sequence having a selected depth, or number of image frames. In the example of FIG. 2, the selected depth is four image frames. Thus, an image frame sequence 110 includes four image frames which are encoded as described above. The encoder fills network buffers to be transmitted over a network to a destination. The transmission of the buffers is represented in FIG. 2 by waveform 120. The information representing image frame sequence 110 is transmitted on the network during interval 130. While the transmitter sends one buffer, the encoder encodes and fills another buffer so that the encoder and the transmitter operate concurrently. At the receiving end, the decoder receives the data buffers from the network and performs decoding as described above. The decoded information produces an image frame sequence 140 which corresponds to image frame sequence 110. While the decoder decodes one received data buffer, the receiver receives another buffer so that the receiver and the decoder operate concurrently.

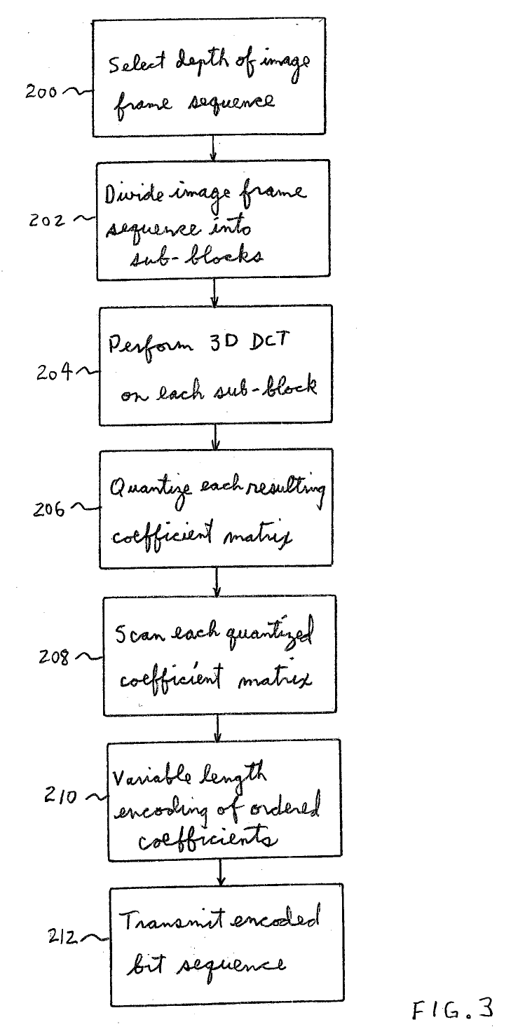

A flow diagram of the encoding process in accordance with an embodiment of the invention is shown in FIG. 3. In step 200, a depth of an image frame sequence is selected to provide a desired performance. As discussed above, a relatively small depth may provide relatively low latency, whereas a relatively large depth may provide high image quality. In step 202, the image frame sequence is divided into sub-blocks, typically having sides of 8×8 and a depth corresponding to the selected depth of the image frame sequence. In step 204, a three-dimensional discrete cosine transform is performed on each sub-block. The result is a three-dimensional coefficient matrix for each sub-block. In step 206, each coefficient matrix is quantized, preferably using a three-dimensional quantization matrix and a quantization factor. In step 208, each quantized coefficient matrix is scanned according to a scan table to provide an ordered set of coefficients. In step 210, variable length encoding of the ordered coefficients is performed. The variable length encoding process may utilize a variable length encoding table to convert the ordered coefficients to an encoded bit sequence. In step 212, the encoded bit sequence is transmitted on the network or other transmission channel.

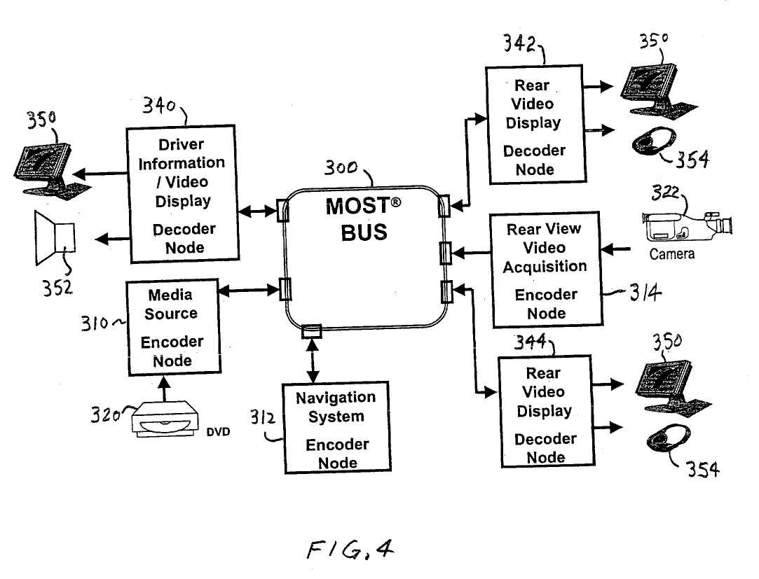

The encoding/decoding technique described herein is particularly useful for distributing video information in vehicles, but is not limited to such applications. A block diagram of a vehicle distribution system utilizing the coding/decoding process in accordance with an embodiment of the invention is shown in FIG. 4. The vehicle distribution system utilizes a network 300 for transporting video information from one or more sources to one or more destinations within the vehicle. In one embodiment, the network 300 may utilize an optical fiber bus system known as the MOST network, developed by MOST Cooperation. Information concerning the MOST network is available at www.mostcooperation.com. In another embodiment, network 300 may utilize a copper electrical bus system, such as IDB1394, D2B or others. Various source nodes and destination nodes are connected to network 300. In the example of FIG. 4, the vehicle distribution system may include a media source encoder node 310, a navigation system encoder node 312 and a rear view video acquisition encoder node 314. The media source encoder node 310 may serve as an interface between a DVD player 320 and network 300. Rear view video acquisition encoder node 314 may serve as an interface between a camera 322 and network 300. The vehicle distribution system may further include a driver information/video display decoder node 340, a rear video display decoder node 342 and a rear video display decoder node 344. Each of the decoder nodes may serve as an interface between network 300 and a video display screen 350 and between network 300 and speaker 352 or headset 354.

In operation, each encoder node may encode video information as described above and transmit the encoded information on network 300, making it available to all decoder nodes. Each decoder node may decode received information and generate a video signal for video display screen 350 and optionally an audio signal for speaker 352 and/or headset 354. The transmitted signals may be received at one or more destinations. In one example, media source encoder node 310 may transmit encoded video from DVD player 320 on the network and one or both rear video display decoder nodes 342 and 344 may decode that information for viewing by passengers in the vehicle. In another example, navigation system encoder node 312 may transmit encoded navigation video information which the driver information/video display decoder node 340 may receive and decode for viewing by the driver of the vehicle. In a further example, rear view video acquisition encoder node 314 may transmit encoded video information from camera 322 on the network, which the to driver information/video display decoder node 340 may decode in addition to decoding the encoded navigation information from encoder node 312, displaying a “picture in picture”.

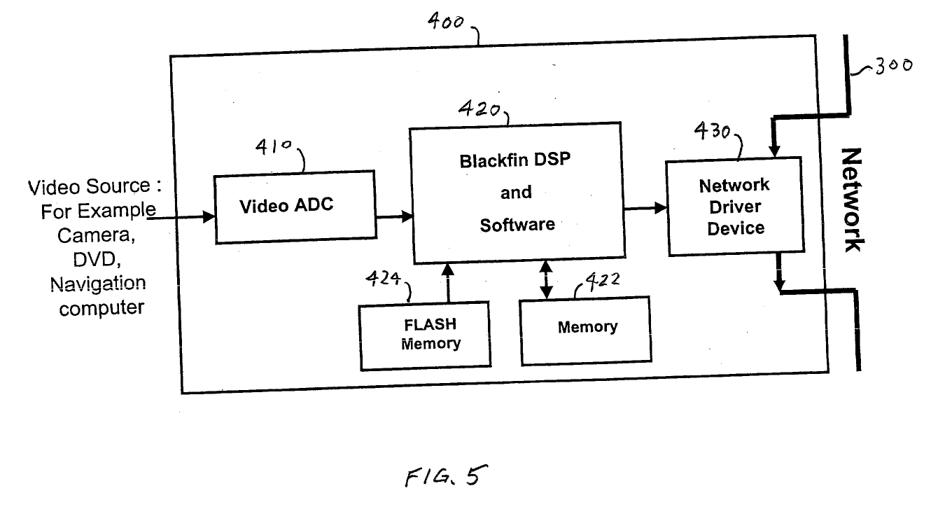

A block diagram of an encoder node 400 in accordance with an embodiment of the invention is shown in FIG. 5. Encoder node 400 may correspond to each of encoder nodes 310, 312 and 314 shown in FIG. 4. Encoder node 400 may include a video analog-to-digital converter 410 for receiving a video signal from a video source, such as a camera, a DVD player or a navigation computer. It will be understood that the video analog-to-digital converter 410 may be omitted if the video source has a digital interface. The digital video signal is supplied to a digital signal processor 420 including software for encoding the video signal as described above. By way of example only, the DSP 420 may be an ADSP-21532 Blackfin DSP manufactured and sold by Analog Devices, Inc. Encoder node 400 may further include a memory 422 and a flash memory 424 both coupled to DSP 420. The encoded video information is supplied by DSP 420 to a network driver device 430 which includes circuitry for transmitting the encoded information on network 300 in accordance with the network protocol. Network driver device 430 may include network buffers for holding information to be transmitted on network 300.

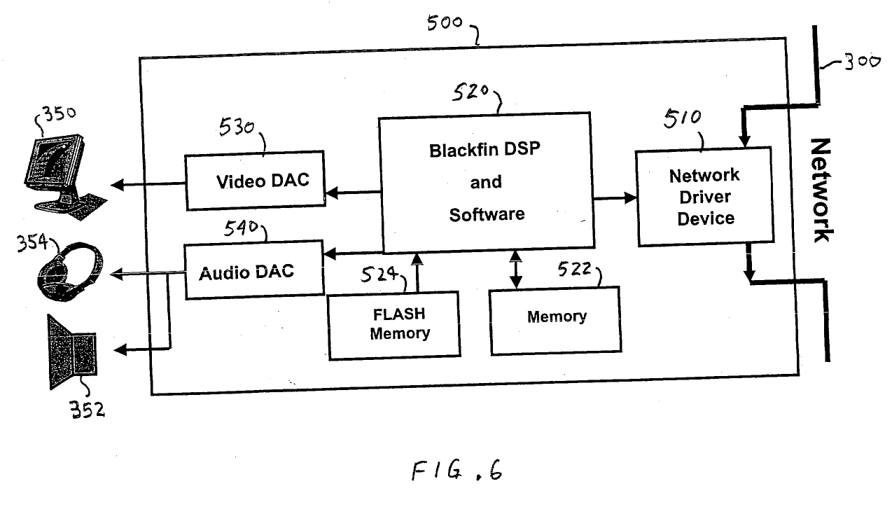

A block diagram of a decoder node 500 in accordance with an embodiment of the invention is shown in FIG. 6. Decoder node 500 may correspond to each of decoder nodes 340, 342 and 344 shown in FIG. 4. Encoded information is received on network 300 by a network driver device 510. Network driver device 510 may include circuitry, including network buffers for receiving information on network 300. The received information is supplied to a DSP 520 having software for decoding encoded information as described above. DSP 520 may for example be an ADSP-21532 Blackfin DSP. Decoder node 500 may further include a memory 522 and a flash memory 524 both coupled to DSP 520. Decoded video information is supplied by DSP 520 through a video digital-to-analog converter 530 to video display screen 350. It will be understood that the video digital-to-analog converter 530 may be omitted if the video display screen 350 has a digital interface. Decoded audio information is supplied by DSP 520 through an audio digital-to-analog converter 540 to headset 354 and/or speaker 352.

In operation, encoded video information is received on network 300 by encoder node 500. The encoded information is decoded as described above and is supplied to the appropriate terminal device. The encoded information may originate at any of the encoder nodes that have access to the network.

As indicated above, the number of image frames in the image frame sequence, also known as the depth of the image frame sequence, is selected to provide a desired performance. The quality of the received image frame sequence and the latency in producing the received image frame sequence are functions of the selected depth of the image frame sequence. A relatively small depth may provide relatively low latency, whereas a relatively large depth may provide high image quality. The depth of the image frame sequence may be selected manually or automatically, or may be pre-programmed. By way of example, a depth of 1, 2, 4 or 8 image frames may be selected. However, other depth values may be utilized within the scope of the invention.

Examples of depth selection are described with reference to FIG. 4. In one example, media source encoder node 310 and rear video display decoder node 342 may be programmed with a relatively large depth to distribute high quality video from DVD player 320 to vehicle passengers. In another example, rear view video acquisition encoder node 314 and driver information/video display decoder node 340 may be programmed with a relatively small depth to distribute video from camera 322 to the vehicle driver with low latency. Furthermore, the depth of the image frame sequence processed by encoder node 314 and decoder node 340 may be varied automatically in response to whether the vehicle is moving forward or backward, since the rate of change of the images is likely to be greater for forward movement than for backward movement of the vehicle. In yet another example, driver information/video display decoder node 340 may have a variable depth of the image frame sequence in response to whether image data is received from navigation system encoder node 312 or rear view video acquisition encoder node 314. The depth utilized by decoder node 340 may be set in response to depth information contained in a header transmitted from the encoder node in advance of encoded video information. In a further example, the vehicle distribution system may have a control input which permits a vehicle occupant to control image quality and/or latency. The control input selects a suitable depth of the image frame sequence.

Based on the above examples, it is apparent that a vehicle distribution system may have a first encoder node and a first decoder node operating at a first depth of the image frame sequence and a second encoder node and a second decoder node simultaneously operating at a second depth of the image frame sequence. The first and second depths may be the same or different. Each depth is selected to provide a desired performance for a particular application.

The coding and decoding method described herein may use run-time, re-configurable, differentiated temporal compression depth, thus making low-latency operation possible. The method utilizes a configurable amount of picture frames when applying the DCT to the temporal information, i.e. the differences in pixel values on a per-frame basis. The current choices are 1, 2, 4 or 8 frames and thus the 3D-DCT is reconfigured at run-time to calculate the transform. This results in a flexible solution that can meet various requirements for the natural trade-offs between latency/bitrate vs. video quality.

The method may use prediction of the DC-component for reduction of bit rate. The DC-components, elements F[0,0,0] in the transformed matrices, for the same sub-blocks in consecutive image frame sequences, carry some redundant information which can be further utilized to decrease bitrate with sustained picture quality. This method calculates the difference between consecutive DC-components for the same sub-blocks over time and transmits that “delta information” instead of the actual DC-component. This scheme is refreshed also at a certain rate to resynchronize the decoder in case a transmission error has occurred. The method is suited best for the cases where a lower number of consecutive frames are utilized, i.e. in profiles where the DC-component occupies a larger proportion of the bitstream.

The method may use pre- and post-processing of visual data, tightly coupled to the deterministic behavior of the artifacts created by the compression method. The methods utilized are selected on basis of the number of frames transformed since typical artifacts appearing in lower depth-profiles are of “blocking” type and “ringing” for depths where more frames are used in the temporal domain (typically 4 or 8). Blocking manifests itself in visible discontinuities between the sub-block borders, giving rise to a checked appearance. Ringing artifacts manifest themselves in visible isolated frequencies in the spatial domain, displaying a smaller sized checked pattern inside the sub-block boundaries.

The quantization-step may be run-time reconfigurable. The quantization harshness can be controlled during run-time to e.g. facilitate bit-rate control.

The method may use a bit rate control mechanism. In order to assure predictability of the network transport and latency considerations, a bit-rate control mechanism may be used.

The method defines an approach to RLE and VLC schemes. A method of generating RLE and VLC tables based on empirical data may be used to arrive at near-optimal look-up tables.

The method defines an approach to zig-zag scan order design. A method of generating zig-zag scan order tables based on empirical data may be used to arrive at near-optimal scan tables.

The method may explore the symmetrical approach of the codec to suit synchronous digital networks, like the ones used in vehicles to support infotainment and driver information applications today. A highly deterministic, computing power-wise, implementation in combination with tightly coupled pre- and post-processing filters and a custom bitrate control mechanism creates a very-near constant bit rate output from the system. This may be used in order to optimally utilize the resources of a synchronous digital network.

The method also may enable the network protocols and services to co-exist on the same computing device (DSP, μP) as the video codec and requires, in comparison to MPEG and ITU-T standards, a low and highly predictable amount of computing power. This relaxes requirements on external interfaces such as memory and inter-ic connectivity and resulting in a cheaper and more efficient system.

The method may define a bit stream format that facilitates run-time reconfiguration and configuration identification. The method may use a header format that serves to communicate crucial information of the encoded bitstream to the decoder and thereby makes it possible for the decoder to reconfigure itself. Video data, such as format of input video, frame rate, colour space may be transmitted as well as the temporal depth, quantization factor and synchronization bit sequences for error resilience.

The method may use a lightweight post-error resynchronization scheme, that is streamlined for usage on physical layers such as the low bit error rate optical digital networks used in vehicles today. The method may use a sequence start code which indicates start of video sequence. This particular sequence is chosen as a most unlikely bit combination to occur in natural encoded video. The method also may use a depth end code indicating the end of encoded frames which the decoder assumes is attached as the last sequence of bits transmitted in a depth of frames. If the decoder does not detect this sequence at this particular bitstream location, it will assume a bit transmission error has occurred and start searching for the sequence start code in the received bitstream and resynchronize itself.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for encoding image data, comprising:
selecting a number of sequential image frames in an image frame sequence to achieve a desired encoding performance;
performing a three-dimensional discrete cosine transform on image data in the image frame sequence to provide a three-dimensional matrix of coefficients; and
processing the coefficients to provide an encoded bit sequence.

2. A method as defined in claim 1, wherein selecting comprises selecting a relatively large number of sequential image frames in the image frame sequence to achieve high image quality.

3. A method as defined in claim 1, wherein selecting comprises selecting a relatively small number of sequential image frames in the image frame sequence to achieve low encoding latency.

4. A method as defined in claim 1, wherein selecting comprises selecting two, four or eight sequential image frames in the image frame sequence.

5. A method as defined in claim 1, wherein performing a three-dimensional discrete cosine transform comprises:
dividing image data representative of the image frame sequence into sub-blocks, wherein each of the sub-blocks has a depth equal to the number of image frames in the image frame sequence, and
performing a three-dimensional discrete cosine transform on the image data in each of the sub-blocks to provide, for each of the sub-blocks, a three-dimensional matrix of sub-block coefficients.

6. A method as defined in claim 5, wherein processing the coefficients comprises quantizing the matrix of sub-block coefficients to provide a matrix of quantized coefficients.

7. A method as defined in claim 5, wherein processing the image data comprises quantizing the matrix of sub-block coefficients based on a three-dimensional quantization matrix and a quantization factor to provide a matrix of quantized coefficients.

8. A method as defined in claim 6, wherein processing the coefficients further comprises arranging the quantized coefficients according to a scan table to provide ordered coefficients.

9. A method as defined in claim 8, wherein processing the coefficients further comprises variable length encoding of the ordered coefficients to provide the encoded bit sequence.

10. A method as defined in claim 8, wherein processing the coefficients comprises variable length encoding of the ordered coefficients using a variable length encoding table to provide the encoded bit sequence.

11. A method as defined in claim 10, wherein variable length encoding further comprises using escape codes to define the encoded bit sequence.

12. Apparatus for encoding image data, comprising:
means for selecting a number of sequential image frames in an image frame sequence to achieve a desired encoding performance;
means for performing a three-dimensional discrete cosine transform on image data in the image frame sequence to provide a three-dimensional matrix of coefficients; and
means for processing the coefficients to provide an encoded bit sequence.

13. A method for encoding image data, comprising:
selecting a number of sequential image frames in an image frame sequence to achieve a desired encoding performance;
dividing image data representative of the image frame sequence into sub-blocks, wherein each of the sub-blocks has a depth equal to the number of image frames in the image frame sequence;
performing a three-dimensional discrete cosine transform on the image data in each of the sub-blocks to provide, for each of the sub-blocks, a three-dimensional matrix of sub-block coefficients; and
processing the sub-block coefficients to provide an encoded bit sequence.

14. A method as defined in claim 13, wherein processing the sub-block coefficients comprises quantizing the sub-block coefficients to provide quantized coefficients, arranging the quantized coefficients in accordance with a scan table to provide ordered coefficients and variable length encoding of the ordered coefficients to provide the encoded bit sequence.

15. A method for transmitting image data from a first location to a second location in a vehicle, comprising:
selecting a number of sequential image frames in an image frame sequence to achieve a desired performance;
performing a three-dimensional discrete cosine transform on image data representative of the image frame sequence to provide a three-dimensional matrix of coefficients;
processing the coefficients to provide an encoded bit sequence;
transmitting the encoded bit sequence from the first location to the second location in the vehicle; and
decoding the encoded bit sequence at the second location to provide a transmitted image frame sequence.

16. A method as defined in claim 15, wherein selecting comprises selecting a number of DVD image frames.

17. A method as defined in claim 15, wherein selecting comprises selecting a number of camera image frames.

18. A method as defined in claim 15, wherein selecting comprises selecting a number of navigation system image frames.

19. A method as defined in claim 15, wherein selecting comprises selecting a number of television image frames.

20. A method as defined in claim 15, wherein selecting comprises selecting a number of video conference image frames.

21. A method as defined in claim 15, wherein performing a three-dimensional discrete cosine transform comprises:
dividing image data representative of the image frame sequence into sub-blocks, wherein each of the sub-blocks has a depth equal to the number of image frames in the image frame sequence, and
performing a three-dimensional discrete cosine transform on the image data in each of the sub-blocks to provide, for each of the sub-blocks, a three-dimensional matrix of sub-block coefficients.

22. A method as defined in claim 15, wherein decoding comprises:
variable length decoding of the encoded bit sequence to provide quantized coefficients;
inverse quantization of the quantized coefficients to provide dequantized coefficients; and
performing an inverse three-dimensional discrete cosine transform on the dequantized coefficients to provide image data representative of the image frame sequence.

23. A method for processing image data to be transmitted from a first location to a second location in a vehicle, comprising:
performing a three-dimensional discrete cosine transform on image data representative of an image frame sequence to provide a three-dimensional matrix of coefficients; and
processing the coefficients to provide an encoded bit sequence for transmission from the first location to the second location in the vehicle.

24. A method for decoding a bit sequence, comprising:
variable length decoding of an encoded bit sequence representative of image data to provide quantized coefficients;
inverse quantization of the quantized coefficients to provide dequantized coefficients; and
performing an inverse three-dimensional discrete cosine transform on the dequantized coefficients to provide image data representative of an image frame sequence.

25. Apparatus for distributing a video signal in a vehicle, comprising:
a network for distributing data in the vehicle;
an encoder node coupled to the network for receiving a video signal from a video source, for performing a three-dimensional discrete cosine transform on image data derived from the video signal to provide a three-dimensional matrix of coefficients and for processing the coefficients to provide an encoded bit sequence for distribution on the network; and
a decoder node coupled to the network for decoding the encoded bit sequence to provide a received video signal.

26. Apparatus as defined in claim 25, further comprising a DVD player coupled to the encoder node for providing the video signal for distribution.

27. Apparatus as defined in claim 25, further comprising a camera coupled to the encoder node for providing the video signal for distribution.

28. Apparatus as defined in claim 25, further comprising a vehicle navigation system coupled to the encoder node for providing the video signal for distribution.

29. Apparatus as defined in claim 25, wherein the encoder node comprises a video analog-to-digital converter for converting the video signal to image data, a digital signal processor for performing the three-dimensional discrete cosine transform and for processing the coefficients to provide the encoded bit sequence, and a network driver device for transmitting the encoded bit sequence on the network.

30. Apparatus as defined in claim 25, further comprising a video display screen coupled to the decoder node for displaying the received video signal.

31. Apparatus as defined in claim 30, further comprising an audio device coupled to the decoder node.

32. Apparatus as defined in claim 25, wherein the decoder node comprises a network driver device for receiving the encoded bit sequence, a digital signal processor for decoding the encoded bit sequence to provide digital values and a video digital-to-analog converter for converting the digital values to the received video signal.

33. Apparatus as defined in claim 25, wherein the network comprises an optical fiber bus system.

34. Apparatus as defined in claim 25, wherein the network comprises an electrical bus system.

35. An encoder node for interfacing a video source to a network, comprising:
a video analog-to-digital converter for converting a video signal to image data;
a digital signal processor including means for performing a three-dimensional discrete cosine transform on the image data to provide a three-dimensional matrix of coefficients and means for processing the coefficients to provide an encoded bit sequence; and
a network driver device for transmitting the encoded bit sequence on the network.

36. An encoder node as defined in claim 35, wherein the means for performing includes means for dividing the image data into sub-blocks, and means for performing a three-dimensional discrete cosine transform on the image data in each of the sub-blocks to provide, for each of the sub-blocks, a three-dimensional matrix of sub-block coefficients.

37. An encoder node as defined in claim 36, wherein the means for processing comprises means for quantizing the sub-block coefficients to provide quantized coefficients, means for arranging the quantized coefficients in accordance with a scan table to provide ordered coefficients and means for variable length encoding of the ordered coefficients to provide the encoded bit sequence.

38. Apparatus for distributing video signals in a vehicle, comprising:
a network for distributing data in the vehicle;
a first encoder node coupled to the network for receiving a first video signal from a first video source, for performing a three-dimensional discrete cosine transform on image data derived from the first video signal to provide a three-dimensional matrix of coefficients and for processing the coefficients to provide a first encoded bit sequence, wherein the image data derived from the first video signal comprises a first image frame sequence having a first depth;
a first decoder node coupled to the network for decoding the first encoded bit sequence to provide a first received video signal;
a second encoder node coupled to the network for receiving a second video signal from a second video source, for performing a three-dimensional discrete cosine transform on image data derived from the second video signal to provide a three-dimensional matrix of coefficients and for processing the coefficients to provide a second encoded bit sequence, wherein the image data derived from the second video signal comprises an image frame sequence having a second depth; and
a second decoder node coupled to the network for decoding the second encoded bit sequence to provide a second received video signal.

39. Apparatus as defined in claim 38, wherein the second depth is different from the first depth.
